(19) United States
(12) Patent Application Publication
(10) Pub. No.: US 2012/0011329 A1
(43) Pub. Date: Jan. 12, 2012

(54) STORAGE APPARATUS AND STORAGE MANAGEMENT METHOD

(75) Inventor: Yusuke Nonaka, Sagamihara (JP)

(73) Assignee: HITACHI, LTD., Tokyo (JP)

(21) Appl. No.: 12/865,901

(22) PCT Filed: Jul. 9, 2010
(86) PCT No.: PCT/JP2010/004472

§ 371 Date: Jun. 3, 2011

(51) Int. Cl. G06F 12/00

(52) U.S. Cl. 711/154; 711/E12.001

(57) ABSTRACT

Pages and files are placed in appropriate storage tiers by comprehensively judging the significance of the pages and files.

A storage apparatus includes: a configuration management unit for managing a storage area as a pool; and an allocation unit for allocating the storage area in the pool to a data storage area for a virtual volume storing data in response to a data write request from a host system. The configuration management unit manages a specified area in the pool as a plurality of subpools for storing file-based data. The allocation unit increases or decreases the allocated capacity of the subpools according to the size of data for which file-based writing is requested by the host system; and if the allocation unit receives a request from the host system to write data on a specified-sized page basis, it allocates an area other than the subpools; and if the allocation unit receives a request from the host system to write data on a file basis, it allocates an area in the subpools.

### TECHNICAL FIELD

The present invention relates to a storage apparatus and a storage management method and is suited for use in, for example, a storage apparatus and storage management method for comprehensively managing storage of data, which are accessed according to a file protocol or a block protocol, in storage tiers.

### BACKGROUND ART

Along with scale expansion and growing complexity of a storage environment due to an increase of company data, thin provisioning utilizing virtual volumes (hereinafter referred to as the virtual volumes) which do not have their own storage areas has become widely used for the purpose of facilitation of operation management and integration of the storage environment.

With the thin provisioning, a virtual volume(s) is presented to a host system. If the host system makes write access to the virtual volume, a physical storage area for actually storing the data is allocated to the virtual volume. As a result, a volume(s) whose capacity is larger than that of the storage areas in the storage apparatus can be presented to the host system, and the storage areas in the storage apparatus can be used very efficiently.

Specifically speaking, with the thin provisioning, one or more logical volumes are defined in a storage area(s) provided by one or more hard disk devices (HDDs: Hard Disk Drives). Also, one storage pool is constituted from one or more logical volumes and each storage pool is associated with one or more virtual volumes. If the host system makes write access to a virtual volume, a storage area in a unit(s) of a predetermined size (the storage area of this size will be hereinafter referred to as the page) is allocated from any of the logical volumes in a storage pool, which is associated with the relevant virtual volume, to the relevant segment of the virtual volume which is write-accessed.

Particularly in these days, storage management is performed efficiently by using a plurality of types of hard disk devices with different performance. For example, by a management method called a Hierarchical Storage Management (HSM), high-significance data is stored in a high-performance storage tier and low-significance data is stored in low-performance storage tier.

For example, Patent Literature 1 discloses a method (page-based tier control) for dividing logical volumes, which are accessed according to the block protocol such as Fibre Channel or iSCSI, into pages that are smaller units, and storing each of pages in different types of storage media in order to realize the above-described tier storage management. As another realization means, Patent Literature 2 discloses a method (file-based tier control) for storing each file for a file system, which is accessed according to the file protocol such as an NFS (Network File System) or a CIFS (Common Internet File System), in different types of storage media.

Furthermore, Patent Literature 3 discloses a technique for enabling access to hard disk devices according to either the file protocol or the block protocol and flexibly allocating the capacity to virtual volumes accessed according to each protocol.

### CITATION LIST

### Non Patent Literature

PTL 1: Japanese Patent Application Laid-Open (Kokai) Publication No. 2007-66259
PTL 2: U.S. Pat. No. 7,143,096
PTL 3: Japanese Patent Application Laid-Open (Kokai) Publication No. 2005-215947

### SUMMARY OF INVENTION

### Technical Problem

However, if an attempt is made to realize the tier storage management described in Patent Literature 3, logical volume data for the block protocol are stored on a page basis in storage media by the page-based tier control. Logical volume data for the file protocol are stored on a file basis in storage media by the file-based tier control. As described above, the methods for storing data in storage media are different between the page-based tier control and the file-based tier control. Therefore, even if storage media belong to the same tier, they have to be divided and different storage media areas have to be secured and used by each tier control. The significance of each page is decided by the page-based tier control, and the significance of each file is decided by the file-based tier control. As a result, there is a problem of inability to comprehensively judge the significance of the pages and the files and place them in appropriate storage tiers.

The present invention was devised in light of the circumstances described above and aims at suggesting a storage apparatus and storage management method capable of using storage media areas efficiently by flexibly changing the allocation of the capacity to storage media areas used by page-based tier control and storage media areas used by file-based tier control.

### Solution to Problem

In order to solve the above-described problem, a storage apparatus connected via a network to a host system issuing a data write request, the storage apparatus including: a configuration management unit for managing a storage area as a pool; and an allocation unit for allocating the storage area of the pool to a data storage area of a virtual volume for storing the data in response to the data write request from the host system is provided according to an aspect of the invention, wherein the configuration management unit manages a specified area of the pool as a plurality of subpools for storing file-based data; and wherein the allocation unit increases or decreases an allocated capacity of the subpools according to the size of data for which file-based writing is requested by the host system; and if the allocation unit receives a request from the host system to write data on a specified-sized page basis, it allocates an area other than the subpools; and if the allocation unit receives a request from the host system to write data on a file basis, it allocates an area in the subpools.

According to the above-described configuration, the storage apparatus stores data, for which a write request has been issued from a host system, in a virtual volume and a specified area in a pool is assigned to a data storage area in the virtual volume. The specified area in the pool is managed as a plurality of subpools for storing file-based data and an allocated capacity of a subpool is increased or decreased according to the size of data for which a file-based write request is issued. If a data write request is issued on a specified-sized-page basis from the host system, an area other than the subpools is allocated; and if a file-based data write request is issued from the host system, an area in the subpools is allocated. In this way, the subpools are provided as volumes, which are accessed according to the file protocol, to the host and the area other than the subpools is provided as volumes, which are accessed according to the block protocol, to the host, so that the capacity of the volumes, which are accessed according to the block protocol, and the capacity of the volumes, which are accessed according to the file protocol, can be changed flexibly according to the capacity of actually stored data.

### Advantageous Effects of Invention

According to this invention, storage media areas can be used efficiently by flexibly changing the allocation of the capacity to storage media areas used by page-based tier control and storage media areas used by file-based tier control.

### BRIEF DESCRIPTION OF DRAWINGS

FIG. 1 is a block diagram showing the overall configuration of a computer system according to a first embodiment of this invention.

FIG. 2 is a block diagram showing the software configuration of a storage apparatus according to the first embodiment.

FIG. 3 is a conceptual diagram showing the outline of conventional processing for placing data to storage tiers.

FIG. 4 is a conceptual diagram showing the outline of processing for placing data to storage tiers according to the first embodiment of this invention.

FIG. 5 is a conceptual diagram showing the logical configuration of storage areas according to the first embodiment.

FIG. 6 is a conceptual diagram showing the relationship between a pool and virtual volumes according to the first embodiment.

FIG. 7 is a conceptual diagram showing the relationship between a pool and sub-storage tiers according to the first embodiment.

FIG. 8 is a chart showing an example of a pool configuration table according to the first embodiment.

FIG. 9 is a chart showing an example of a logical volume configuration table according to the first embodiment.

FIG. 10 is a conceptual diagram showing the correspondence relationship between file systems and sub-storage tiers according to the first embodiment.

FIG. 11 is a conceptual diagram showing the correspondence relationship between blocks and pages in the file systems according to the first embodiment.

FIG. 12 is a chart showing an example of a sub-storage tier capacity allocation table according to the first embodiment.

FIG. 13 is a chart showing an example of a file attribute table according to the first embodiment.

FIG. 14 is a chart showing an example of migration policies according to the first embodiment.

FIG. 15 is a chart showing an example of an object attribute table according to the first embodiment.

FIG. 16 is a chart showing an example of an object attribute table according to the first embodiment.

FIG. 17 is a chart showing an example of an object attribute table according to the first embodiment.

FIG. 18 is a flowchart illustrating storage tier deciding processing according to the first embodiment.

FIG. 19 is a flowchart illustrating file migration processing according to the first embodiment.

FIG. 20 is a flowchart illustrating file deletion processing according to the first embodiment.

FIG. 21 is a flowchart illustrating file write processing according to the first embodiment.

FIG. 22 is a flowchart illustrating processing for reducing a desired number of pages according to the first embodiment.

FIG. 23 is a block diagram showing the configuration of a storage apparatus according to a second embodiment of the invention.

FIG. 24 is a block diagram showing the configuration of a storage apparatus according to a third embodiment of the invention.

### DESCRIPTION OF EMBODIMENTS

An embodiment of this invention will be explained with reference to the attached drawings.

### (1) First Embodiment

### (1-1) Hardware Configuration of Computer System

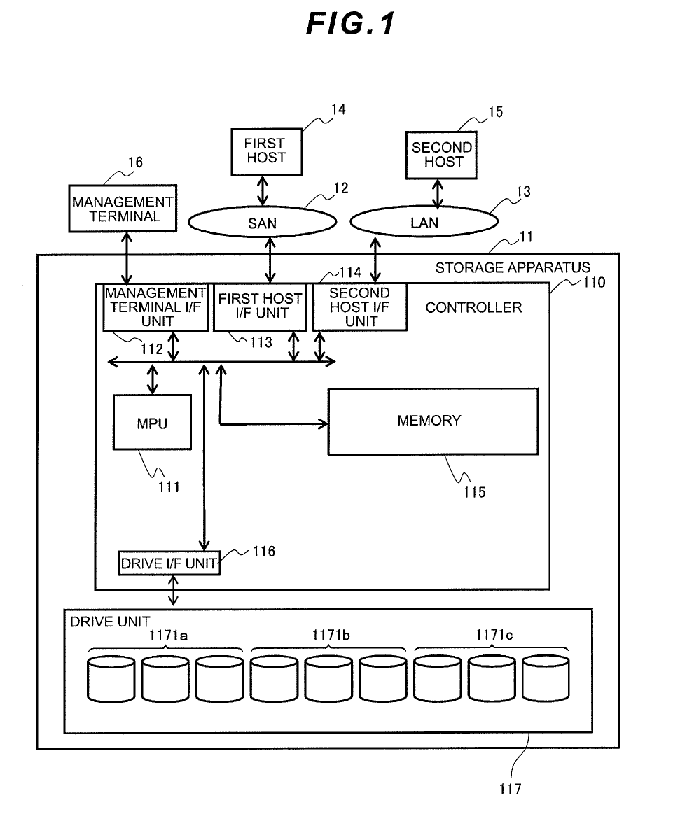

The hardware configuration of a computer system 1 according to this embodiment will be firstly explained with reference to FIG. 1. As shown in FIG. 1, the computer system 1 according to this embodiment includes a storage apparatus 11, a SAN (Storage Area Network) 12, a LAN (Local Area Network) 13, a first host 14, a second host 15, and a management terminal 16.

The first host 14 or the second host 15 is a computer system equipped with information resources such as a CPU (Central Processing Unit) and a memory and is composed of, for example, a personal computer, a workstation, or a mainframe. The CPU serves as a processor controller and controls the operation of the entire first host 14 and second host 15 according to, for example, programs and operational parameters stored in the memory. Main programs stored in the memory will be explained later in detail. The first host 14 and the second host 15 may also include information input devices such as a keyboard, switch, pointing device, and microphone, and information output devices such as a monitor display and speaker.

The first host 14 is connected via the SAN 12 to the storage apparatus 11 and communication between the devices is performed by means of block-based writing/reading according to the block protocol such as SCSI. The second host 15 is connected via the LAN 13 to the storage apparatus 11 and communication between the devices is performed by means of file-based writing/reading according to the file protocol such as NFS.

Incidentally, the host and network using the block protocol and the host and network using the file protocol are configured separately in this embodiment, but the invention is not limited to this example. For example, one host may use both the block protocol and the file protocol to access the storage apparatus 11. Alternatively, both the block protocol and the file protocol may share the network and an interface for the storage apparatus 11.

The storage apparatus 11 has a function that changes parameters, such as the configuration of logical volumes in storage areas, in accordance with a command sent from the management terminal 16 and is mainly constituted from a controller 110 and a drive unit 117.

The controller 110 interprets a command sent from the first host 14 or the second host 15 and executes reading data from, or writing data to, a storage area included in the drive unit 117. The controller 110 includes, for example, information processing resources such as an MPU (Micro Processing Unit) 111, a memory 115, a management terminal I/F unit 112, a first host I/F unit 113, a second host I/F unit 114, and a drive I/F unit 116.

The MPU 111 serves as a processor controller and controls the operation of the entire storage apparatus 11 according to, for example, programs and operational parameters stored in the memory 115. The memory 115 can be accessed by the MPU 111 at a high performance and stores various programs to be executed by the MPU 111. Main programs stored in the memory 115 will be explained later in detail. The management terminal I/F unit 112 is connected to the management terminal 16, the first host I/F unit 113 is connected to the first host 14, the second host I/F unit 114 is connected to the second host 15, and the drive I/F unit 116 is connected to the drive unit 117. The management terminal I/F unit 112, the first host I/F unit 113, the second host I/F unit 114, and the drive I/F unit 116 are interfaces for sending or receiving various pieces of information.

The drive unit 117 is constituted from a plurality of storage media 1171a, 1171b, and 1171c (hereinafter sometimes simply referred to as the storage media 1171). The plurality of storage media are constituted from a plurality of types (classes) of storage media with different performance and bit costs, and examples of such storage media can include expensive hard disk drives such as SCSI (Small Computer System Interface) disks or inexpensive hard disk drives such as SATA (Serial AT Attachment) disks. Furthermore, other than the hard disks, the plurality of storage media may be flash memories or different types of storage media with different performance may be mixed. In this embodiment, for example, three different classes of storage media are provided: the storage media 1171a are high-tier (class A) storage media with the highest performance and reliability; the storage media 1171b are medium-tier (class B) storage media with the second highest performance and reliability; and the storage media 1171c are low-tier (class C) storage media with the lowest performance and reliability.

The management terminal 16 is a computer device equipped with information processing resources such as a CPU and a memory and manages the disks, etc. of the storage apparatus 11 in accordance with input by, for example, an operator. The management terminal 16 is connected to the storage apparatus 11 via a LAN or similar and is composed of, for example, a personal computer.

### (1-2) Software Configuration of Storage Apparatus

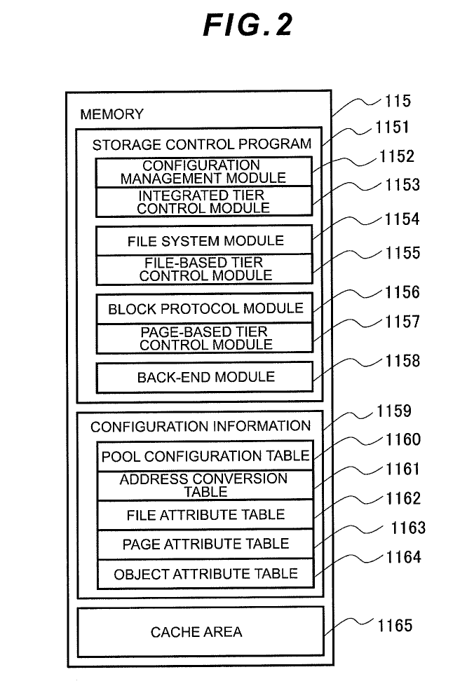

Next, the main software configuration of the storage apparatus 11 will be explained with reference to FIG. 2. As shown in FIG. 2, the memory 115 for the storage apparatus 11 mainly includes a storage control program 1151, configuration information 1159, and a cache area 1165.

The storage control program 1151 is a program to be executed by the MPU 111 and constituted from program modules such as a configuration management module 1152, an integrated tier control module 1153, a file system module 1154, a file-based tier control module 1155, a block protocol module 1156, a page-based tier control module 1157, and a back-end module 1158.

The configuration management module 1152, for example, updates or refers to each table included in the configuration information 1159 described later in accordance with a command from the management terminal 16 or an instruction or similar from other program modules. The file system module 1154 interprets a command sent from the second host 15 according to the file protocol on the basis of the configuration of a file system defined in part of storage areas and inputs or outputs it to the back-end module 1158. The file-based tier control module 1155 executes processing relating to file-based tier control with respect to each file handled by the file system module 1154, such as deciding a storage tier to store the relevant file or mapping between file paths and addresses in the storage tiers.

The block protocol module 1156 interprets a command sent from the first host 14 to a virtual volume according to the block protocol and requests data input/output by the back-end module 1158. The page-based tier control module 1157 executes processing relating to page-based tier control with respect to each page obtained by dividing virtual volumes handled by the block protocol module 1156, such as deciding a storage tier to allocate a storage area to the relevant page or mapping between addresses in the virtual volumes and addresses in the storage media.

The back-end module 1158 executes data cache processing by using the cache area 1165, RAID (Redundant Arrays of Independent Disks) processing, and input to, or output from, the storage media included in the drive unit 117 in accordance with a request from the file system module 1154 or the block protocol module 1156.

The integrated tier control module 1153 controls the file-based tier control module 1155 and the page-based tier control module 1157 so that the files and pages are stored in the storage tiers as described above in an optimum manner in the storage apparatus 11 as a whole. The integrated tier control module 1153 places the files or the pages in an optimum storage tier in the storage pool constituted from a plurality of hard disk devices according to the significance or a specified policy. As a result, it is possible to comprehensively judge, for example, the significance, regardless of the types of pages and files, and place them in an appropriate storage tier. Since the integrated tier control module 1153 defines the files and the pages as objects, that is, the concept including the files and the pages, the files and the pages may sometimes be referred to and explained as the objects.

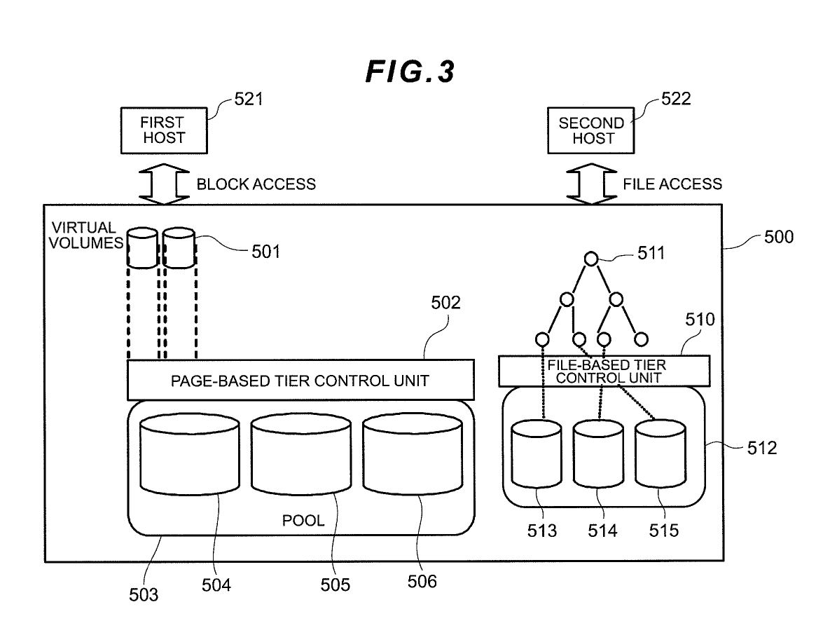

Now, the outline of conventional processing for placing pages and files in storage tiers and processing for placing pages and files in storage tiers according to this embodiment will be explained. Conventionally, as shown in FIG. 3, logical volumes 504 to 506 for the block protocol are managed by a page-based tier control module and logical volumes 513, 514, and 515 for the file protocol are managed by a file-based tier control module. Therefore, it is impossible to integrate the logical volumes 504 to 506 and 513 to 515 and treat them as one storage pool, and each tier control module decides a storage tier to store pages or files within divided capacities. As a result, it is impossible to execute optimum data placement in the storage apparatus as a whole.

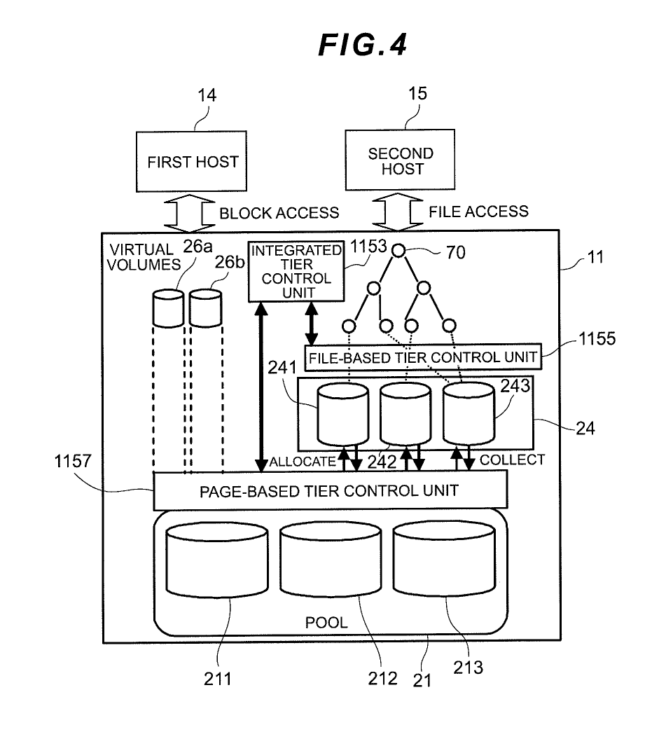

Meanwhile, in this embodiment, the logical volumes for the file protocol and the logical volumes for the block protocol are integrated to constitute one or more storage pools having a plurality of storage tiers. As shown in FIG. 4, a storage pool 21 is constituted from, for example, three storage tiers 211, 212, and 213 with different characteristics such as performance. Page-based tier control is performed with respect to each storage tier 211 to 213, but part of the storage pool 21 is designed so that a storage tier can be decided on a file basis. Specifically speaking, part of the capacity of the storage tier 211 is set as a sub-storage tier 241, part of the capacity of the storage tier 212 is set as a sub-storage tier 242, and part of the capacity of the storage tier 213 is set as a sub-storage tier 243, and each sub-storage tier 241 to 243 is allocated as one virtual volume. As a result, the file-based tier control module 1155 can treat each sub-storage tier 241 to 243, which is configured by cutting out part of the capacity of the storage tiers, as if it were one logical volume.

If the second host 15 makes file-based access, the file-based tier control module 1155 writes data to the relevant page in the sub-storage tier 241, 242, or 243 which is part of the capacity of the storage tier 211, 212, or 213. The page-based tier control module 1157 allocates any of pages in the storage tier 211, 212, or 213 in the storage pool 21, which are associated with the sub-storage tier 241, 242, or 243, to the page written to any of the sub-storage tier 241, 242, or 243 by means of a thin provisioning function.

In this way, it is possible to treat the logical volumes for the block protocol and the logical volumes for the file protocol as one storage pool by utilizing part of the capacity of the storage tiers as the sub-storage tiers for file-based tier control. Moreover, the integrated tier control module 1153 compares, for example, the significance included in the attribute information about each file and the attribute information about each page as described earlier and then decides storage tiers to place the files and pages. Furthermore, the integrated tier control module 1153 decides a storage tier to place each object as described above and then decides the capacity (number of pages) of the storage tier to be allocated to the sub-storage tier based on the above decision.

The file-based tier control module 1155 and the page-based tier control module 1157 executes migration of each file and each page between the storage tiers based on the decision of the integrated tier control module 1153. When the migration is executed, an empty page where any file is not allocated in either one of the sub-storage tiers 214 to 243 with a specified capacity already allocated may be generated due to the file migration. The file-based tier control module 1155 notifies the page-based tier control module 1157 of information for identifying the empty page. The page-based tier control module 1157 collects the page based on the information for identifying the empty page as notified by the file-based tier control module 1155 and reduces the capacity of the sub-storage tier. As a result, it is possible to flexibly change the capacity of an area used by the file-based tier control module 1155 according to the capacity of data actually stored.

Referring back to FIG. 2, the content of each table included in the configuration information 1159 stored in the memory 115 will be explained. The configuration information 1159 includes, for example, a pool configuration table 1160, an address conversion table 1161, a file attribute table 1162, a page attribute table 1163, and an object attribute table 1164. The pool configuration table 1160 is a table that decides the logical configuration of storage areas implemented by a plurality of storage media included in the drive unit 117. The pool configuration table 1160 defines the configurations of a RAID group(s) for realizing the RAID with a plurality of storage media, a storage tier(s) constituted from one or more RAID groups in the same tier, a storage pool(s) constituted from a plurality of storage tiers, and logical volumes defined as part of areas of the storage pools or the RAID groups.

The address conversion table 1161 stores mapping between addresses in the virtual volumes and addresses in the storage pool with respect to the virtual volumes to which an actual area is allocated on a page basis from the storage pool by means of the thin provisioning function. The file attribute table 1162 stores the attribute information about each file included in the file system. The page attribute table 1163 stores the attribute information about each page for the page-based tier control. The file attribute information and the page attribute information are information that serves as the base for deciding placement of each file or each page to the storage tier; and examples of the file or page attribute information are the access frequency and the last access date and time.

The object attribute table 1164 stores information about, for example, the significance of each object included in the storage apparatus 11 with respect to objects defined as a superordinate concept including the files and the pages. Various pieces of information stored in each table will be explained later in detail.

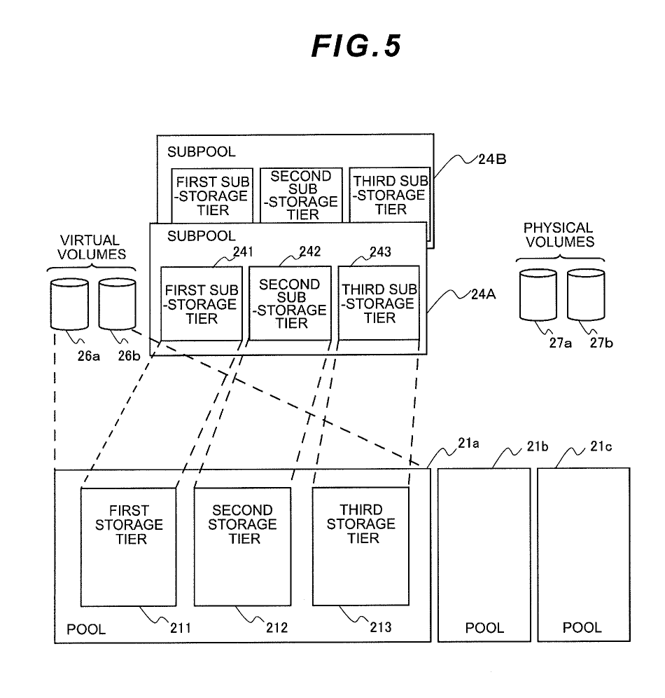

Next, the logical configuration of storage areas defined by the above-described pool configuration table 1160 will be explained with reference to FIG. 5. A pool 21a, a pool 21b, and a pool 21c (hereinafter sometimes referred to as the pool 21) are examples of the aforementioned storage pools and are logical storage area units realized by a set of storage media. The storage pool(s) will be hereinafter sometimes simply referred to as the pool(s). The first storage tier 211, the second storage tier 212, and the third storage tier 213 are examples of the aforementioned storage tiers and are obtained by classifying the inside of the storage pool by storage media classes. In this embodiment, a storage pool is constituted from three storage tiers: for example, the first storage tier is composed of a high tier (class A), the second storage tier is composed of a medium tier (class B), and the third storage tier is composed of a low tier (class C).

Subpools indicating storage areas, each of which is part of a storage pool can be defined in the storage pool. In this embodiment, for example, a subpool 24A and a subpool 24B are defined in the pool 21a. The subpool 24A and the subpool 24B will be sometimes simply referred to as the subpool 24. Furthermore, each subpool can be divided into a plurality of storage tiers. For example, the subpool 24 is constituted from three storage tiers: a first sub-storage tier 241, a second sub-storage tier 242, and a third sub-storage tier 243. The first sub-storage tier 241, the second sub-storage tier 242, and the third sub-storage tier 243 are part of the first storage tier 211, the second storage tier 212, and the third storage tier 213 of the same class respectively. For example, the first sub-storage tier is part of the first storage tier in the same tier. Furthermore, an area which is not allocated to any of the sub-storage tiers, from among the storage tiers belonging to the pool 21, is defined as a root storage tier.

One or more virtual volumes can be associated with each pool. Virtual volumes 26a and 26b (hereinafter referred to as the virtual volume 26) are provided as virtual volumes that can be accessed from the first host 14 according to the block protocol. An arbitrary page in the root storage tier which is not allocated to the sub-storage tiers is allocated to each page of the virtual volumes 26. Also, physical volumes 27a, 27b (hereinafter referred to as the physical volume 27) can be defined in a storage area not included in the pool 21.

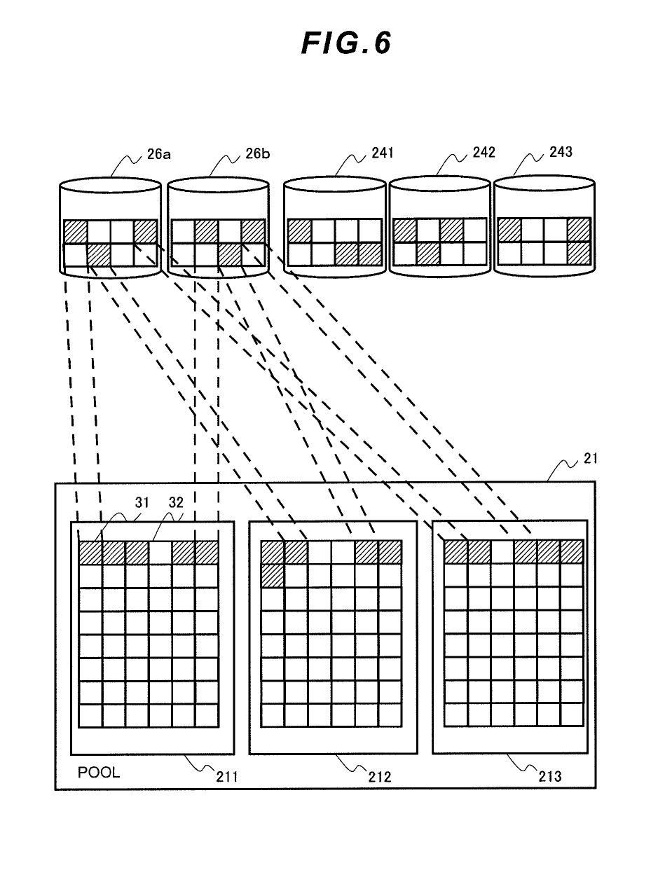

Next, the relationship between the pool 21 and the virtual volumes 26 will be explained with reference to FIG. 6. As shown in FIG. 6, the actual capacity has not been allocated yet to, or any of the pages in the first to the third storage tiers 211, 212, or 213 included in the pool 21 is allocated to, each page constituting the virtual volumes 26. Furthermore, each page constituting each storage tier 211, 212, and 213 becomes either a page (for example, a page 31) already allocated to any of the pages in the virtual volumes 26, or an unallocated page (for example, a page 32).

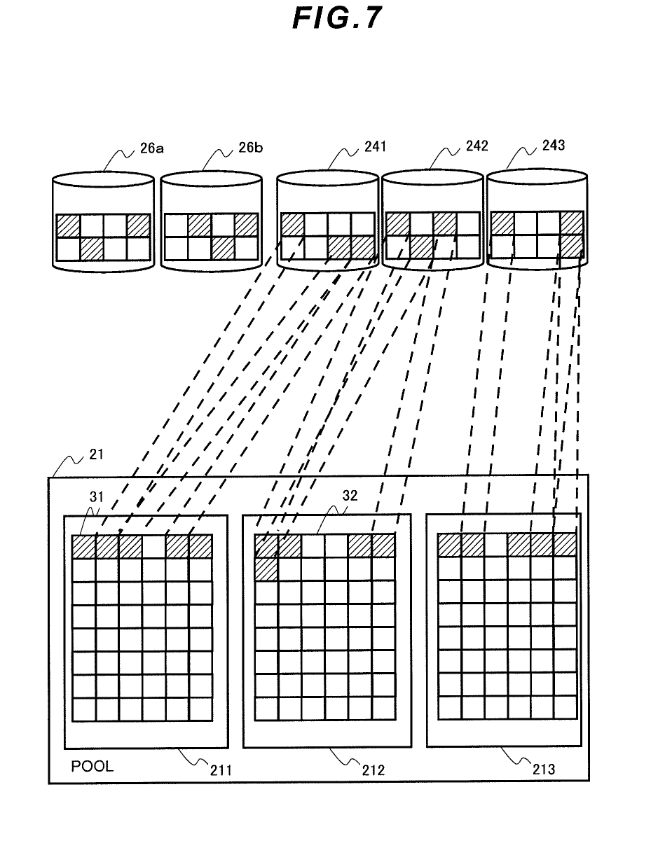

Next, the relationship between the pool 21 and the sub-storage tiers 241 to 243 will be explained with reference to FIG. 7. The actual capacity has not been allocated yet to, or a page in a storage tier composed of storage media of the same class is allocated to, each page constituting the sub-storage tier. The sub-storage tier is provided as a virtual volume, whose storage tier for the pages allocated to the sub-storage tier is fixed, to the first host 15. For example, the pages in the first storage tier 211 of the same class as that of the first sub-storage tier 241 are always allocated to pages included in the first sub-storage tier 241.

Accordingly, the virtual volumes 26, the first sub-storage tier 241, the second storage tier 242, and the third storage tier 243 are virtual volumes presented to the first host 14 or the second host 15. In this embodiment, the capacity of the storage tiers (number of pages) is secured in advance as the sub-storage tiers, thereby making it possible to provide part of the storage tiers to the file system.

### (1-3) Details of Functions of Storage Apparatus

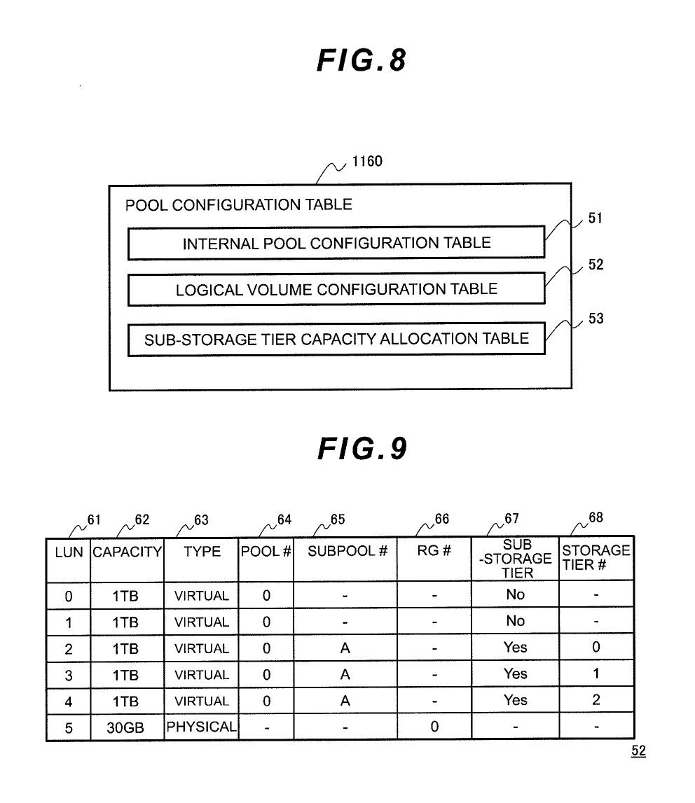

Next, specific functions of the storage apparatus 11 will be explained with reference to FIG. 8 to FIG. 17. The logical configuration of the storage areas which is realized by a plurality of storage media included in the drive unit 117 as described above is decided by the pool configuration table 1160 included in the configuration information 1159 in the memory 115. The content of the pool configuration table 1160 in the configuration information 1159 in the memory 115 will be explained with reference to FIG. 8. As shown in FIG. 8, the pool configuration table 1160 includes an internal pool configuration table 51, a logical volume configuration table 52, and a sub-storage tier capacity allocation table 53.

The internal pool configuration table 51 stores, for example, configuration information about RAID groups, configuration information about the storage tiers in each pool, and the capacity of one page in the pool (page size). The logical volume configuration table 52 stores attribute information about each logical volume included in the storage apparatus 11. The details of the logical volume configuration table 52 will be explained with reference to FIG. 9. As shown in FIG. 9, the logical volume configuration table 52 includes an LUN column 61, a capacity column 62, a type column 63, a pool number column 64, a subpool number column 65, a RAID group number column 66, a sub-storage tier column 67, and a storage tier number column 68.

The LUN column 61 stores information indicating the identification number of the relevant logical volume. The capacity column 62 stores information indicating the capacity recognized by the first host 14 or the second host 15. The capacity stored in the capacity column 62 corresponds with the actual capacity in a case of a physical volume, but may be larger than the actual capacity in a case of a virtual volume.

In the case of a virtual volume, the pool number column 64 stores information for identifying a pool to which the relevant virtual volume belongs. If a virtual volume is defined as a sub-storage tier, the subpool number column 65 stores information for identifying a subpool to which the relevant sub-storage tier belongs. FIG. 9 shows that LUN2, LUN3, LUN4 for which A is stored in the subpool number column 65 are defined as sub-storage tiers and belong to subpool A.

In the case of a physical volume, the RAID group number column 66 stores information for identifying a RAID group to which the relevant physical volume belongs. The sub-storage tier column 67 stores information indicating whether or not the relevant virtual volume is defined as a sub-storage tier. FIG. 9 shows that LUN2, LUN3, LUN4 for which YES is stored in the sub-storage tier column 67 are sub-storage tiers. The storage tier number column 68 stores information for identifying the storage tier number associated with a sub-storage tier with respect to the relevant virtual volume defined as a sub-storage tier.

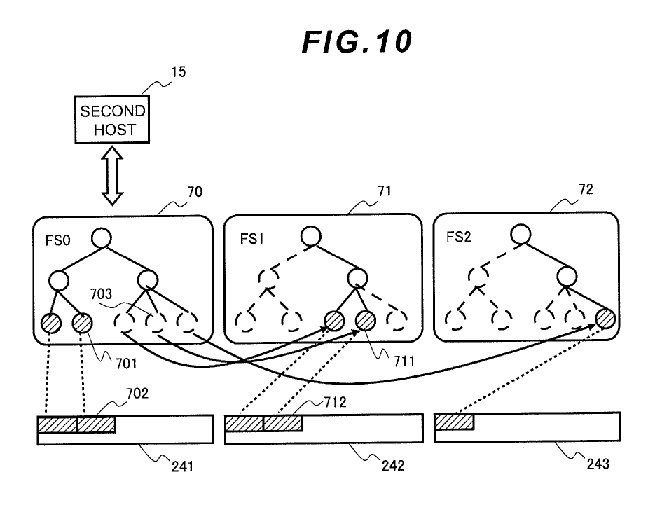

Now, the correspondence relationship between file systems and sub-storage tiers will be explained with reference to FIG. 10. The subpool 24 is an area managed by the file system module 1154 and accessed by the file protocol as described earlier. The subpool 24 is also used as an area where the file-based tier control is executed by the file-based tier control module 1157. Each sub-storage tier included in the subpool 24 is recognized as a logical volume by the file system module 1154 and a file system is configured for each sub-storage tier. For example, a file system FS0 is configured in the first sub-storage tier 241, a file system FS1 is configured in the second sub-storage tier 242, and a file system FS2 is configured in the third sub-storage tier 243 as shown in FIG. 10.

The second host 15 normally accesses the file system FS0 configured in the sub-storage tier 241 belonging to the first storage tier 211 which is the highest tier. For example, since the significance of a file 701 included in the file system FS0 is high, the file 701 is placed in the first sub-storage tier belonging to the first storage tier 211 which is the highest tier. Actual data of the file 701 is stored in a block 702 in a page included in the first sub-storage tier 241. A file 703 is a file whose actual data is not stored in the first sub-storage tier 241. The file system FS0 retains a pointer (stub) indicating the position of the actual data of the file 703. Specifically speaking, the file system FS0 retains information indicating that the file 703 is included in the file system FS1 and the actual data of the file 703 is a file 711. The actual data of the file 703 is stored in a block 712 in the second sub-storage tier 242 corresponding to the file system FS1.

An example where a file system is configured in each sub-storage tier has been explained as a method for realizing the file-based tier control; however, the method for realizing the file-based tier control is not limited to this example. For example, a file system may be configured only in the first sub-storage tier belonging to the first storage tier which is the highest tier, and other sub-storage tiers may manage actual data by means of a data structure different from the file system. An example of the data structure different from the file system can be a simpler data structure for managing only the data length and start addresses in order to identify objects by indicating actual data of files.

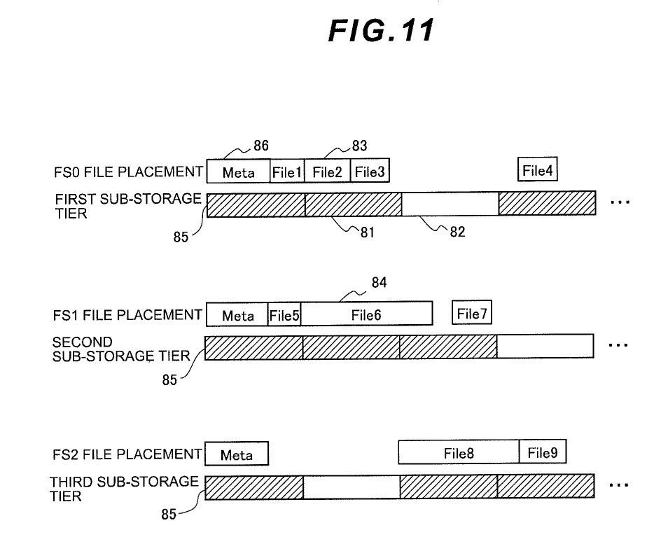

Next, the correspondence relationship between blocks storing actual data of each file in a file system and pages in a sub-storage tier will be explained with reference to FIG. 11. As shown in FIG. 11, a page group 85 constituting each sub-storage tier is a fixed-length area, but a variable-length block is allocated to a file in a file system. FIG. 11 shows that blocks allocated to files included in a file system configured in each sub-storage tier are placed above the page group 85. For example, metadata of a file system (Meta 86) and actual data (such as File1, File2) are allocated to each block.

Each page included in each sub-storage tier is an allocated page to which an actual area of the corresponding storage tier is allocated, or an unallocated page. For example, a page 81 is an allocated page because, for example, a file 83 is included. Since a page 82 does not include any file, it is an unallocated page.

The file-based tier control module 1157 obtains the page size of the pool to which the sub-storage tiers stored in the internal pool configuration table 51 belong. Then, the file-based tier control module 1157 controls block allocation at the time of creation or update of a file so that a file block will not be allocated to extend across a plurality of pages, except for a file whose size exceeds the page size (for example, a file 84). As a result, for example, if a file deletion is executed, the probability of collecting pages can be increased. Collection of pages will be explained later in detail.

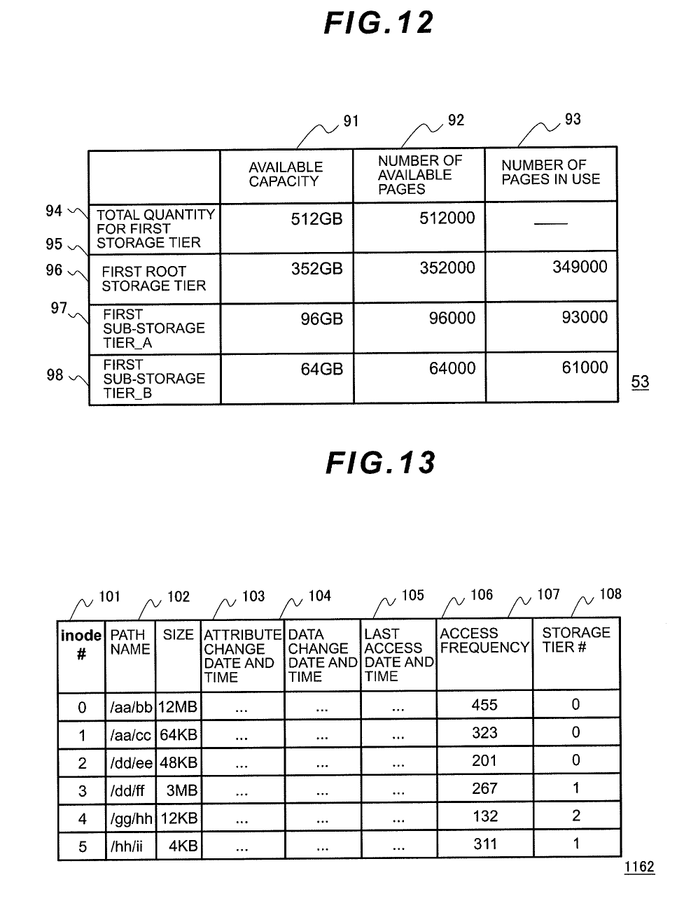

Next, the content of the sub-storage tier capacity allocation table 53 included in the pool configuration table 1160 will be explained with reference to FIG. 12. The sub-storage tier capacity allocation table 53 stores information for deciding the capacity allocation to the sub-storage tiers of the same class as that of each storage tier included in a subpool belonging to a pool with respect to each storage tier belonging to an arbitrary pool.

For example, the sub-storage tier capacity allocation table 53 shown in FIG. 12 stores, for example, an available capacity of the sub-storage tiers and the root storage tier of the first storage tier belonging to each pool. As shown in FIG. 12, the sub-storage tier capacity allocation table 53 includes an available capacity column 91, a number-of available-pages column 92, and a number-of-pages-in-use column 93. With respect to the whole (total) quantity of the first storage tier, the available capacity column 91 stores the available capacity of the whole first storage tier and the number-of-available-pages column 92 stores the number of available pages in the whole first storage tier. The number-of-pages-in-use column 93 does not store a total value with respect to the whole first storage tier.

With regard to each of the first root storage tier, the first sub-storage tier_A, and the first storage tier_B, the available capacity column 91 stores the available capacity, the number-of-available-pages column 92 stores the number of available pages, and the number-of-pages-in-use column 93 stores the number of pages in use. If a plurality of subpools 24 are defined in a pool 21, information such as the number of available pages in sub-storage tiers belonging to each subpool is stored.

The available capacity column 91 for the first root storage tier 96 stores the actual capacity, which is not allocated to any sub-storage tier, from among the actual capacity of the pool 21; and the number-of-available-pages column 92 stores the number of pages corresponding to the available capacity. The number-of-pages-in-use column 93 stores the number of pages already allocated to the virtual volume 26.

The available capacity column 91 for the first sub-storage tier_A 97 stores the actual capacity, which is allocated to the first sub-storage tier 241 belonging to the subpool A, from among the actual capacity of the pool 21; and the number-of-available-pages column 92 stores the number of pages corresponding to the available capacity. The number-of-pages-in-use column 93 stores the number of pages already allocated to the virtual volume corresponding to the first sub-storage tier belonging to the subpool A.

Furthermore, the available capacity column 91 for the first sub-storage tier_B 98 stores the actual capacity, which is allocated to the first sub-storage tier belonging to the subpool B, from among the actual capacity of the pool 21; and the number-of available-pages column 92 stores the number of pages corresponding to the available capacity. The number-of-pages-in-use column 93 stores the number of pages already allocated to the virtual volume corresponding to the first sub-storage tier belonging to the subpool B.

Allocation of the above-described available capacity 91 (the number of available pages 92) is decided by the integrated tier control module 1153 based on the attribute information about each storage tier. Specifically speaking, the integrated tier control module 1153 decides allocation of the available capacity (the number of available pages) based on a rate of the total capacity of high-significance objects included in the root storage tier or each sub-storage tier. Furthermore, allocation of the available capacity (the number of available pages) may be decided according to input by the user via the management terminal 16. A method for deciding allocation of the available capacity for each storage tier will be explained later in detail.

Next, the content of the file attribute table 1162 included in the configuration information 1159 will be explained with reference to FIG. 13. The file attribute table 1162 stores attribute information about each file included in a file system. FIG. 13 shows an example where the attribute information about files included in a file system configured in the subpool A in the pool 21. The invention is not limited to the case where the attribute information about each file is stored in the file attribute table 1162 shown in FIG. 13; and the attribute information about each file may be stored in a data structure specified by individual file systems.

As shown in FIG. 13, the file attribute table 1162 includes, for example, an i-node number column 101, a path name column 102, a size column 103, an attribute change date and time column 104, a data change date and time column 105, a last access date and time column 106, an access frequency column 107, and a storage tier number column 108. The i-node number column 101 stores the identification number of the relevant file in the file system. In this embodiment, a file system is configured in each sub-storage tier and each file is identified by a value stored in the i-node number column for the file system configured in the highest sub-storage tier.

The path name column 102 stores a character string that is information for identifying a file when accessed by the second host 15. The size column 103 stores the data size of each file. The attribute change date and time column 104 stores a date and time when a file attribute was changed last time. The file attribute means information indicating metadata of the relevant file such as the path name of the relevant file and the number of accesses. The data change date and time column 105 stores a date and time when data of the relevant file was changed last time. The last access date and time column 106 stores a date and time when data of the relevant file was accessed (for example, reference was made to the data of the file or the data of the file was updated) last time.

The access frequency column 107 stores frequency of access to the relevant file. The access frequency is a quantified value in accordance with a specific standard. An example of the specific standard can include the number of accesses per unit time such as per day or per week. An example of a method for obtaining the number of accesses per unit time includes a method for recording the number of accesses for a certain period of time (for example, three hours) and calculating the total number of accesses retroactive to immediately preceding period(s) of time. If the unit time is set to one day, the total number of access for the past eight 3-hour periods will be calculated.

The storage tier number column 108 stores information indicating a sub-storage tier where the relevant file is placed. Specifically speaking, it is information indicating in which sub-storage tier the entity of each file is stored.

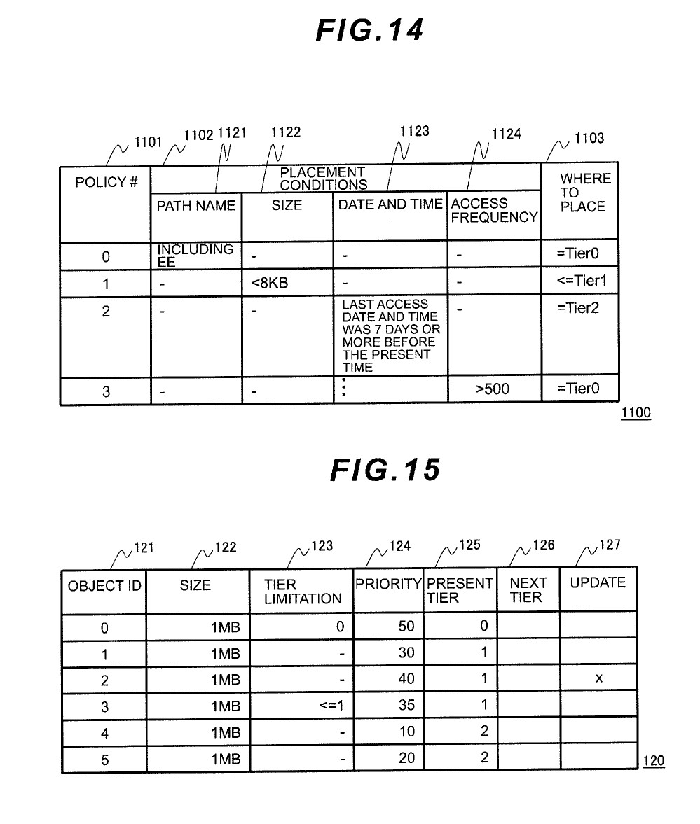

Next, migration policies to be used by the file-based tier control module 1155 for the file-based tier control will be explained with reference to FIG. 14. The migration policies shown in FIG. 14 is a table 1100 to which the file-based tier control module 1155 refers to when executing the file-based tier control; and the table 1100 may be included in the file attribute table 1162 or may be stored in the memory 115 separately from the file attribute table 1162.

As shown in FIG. 14, the table 1100 storing a list of migration policies includes a policy number column 1101, a placement condition column 1102, and a where-to-place column 1103. The policy number column 1101 stores an identification number of the relevant policy. The placement condition column 1102 includes a path name column 1121, a size column 1122, a date-and-time column 1123, and an access frequency column 1124. If a placement condition(s) is set to each policy, the relevant condition(s) is stored in the relevant column(s).

For example, the path name column 1121 stores a character string such as including ee. If the path name column 1121 stores the character string, whether or not the designated character string is included in the entire file name or in its extension is set as a placement condition. The size column 1122 includes, for example, a value such as <8 KB. If the size column 1122 stores such a value, whether or not the size is larger than or not larger than (smaller than) the designated size is set as a placement condition. The date-and-time column 1123 stores a character string such as the last access date and time was 7 days or more before the present time. If the date-and-time column 1123 stores that character string, whether or not the last access date and time was 7 days or more before the present time is set as a placement condition. Also, whether or not a value of a reference date and time, which is one of the attribute change date and time, the data change date and time, and the last access date and time, is past a designated date and time is set as a placement condition according to the character string stored in the date-and-time column 1123.

If a value indicating the access frequency is stored in the access frequency column 1124, whether or not the value is higher than or not higher than (lower than) the designated access frequency is set as a placement condition. The placement condition column 1102 may store, besides the path name, size, date and time, and access frequency, other attributes included in a general file system such as attributes relating to a file access right such as a file owner or file permission. Furthermore, the priority of the placement conditions may be decided according to the ascending order of the policy number column 1101.

The where-to-place column 1103 stores information for specifying a storage tier where the file specified by the placement condition 1102 can be placed. For example, if the where-to-place column 1103 stores=Tier0, it indicates that the location to place the file that satisfies the placement condition is limited to Tier0 (the first storage tier). If the where-to-place column 1103 stores <=Tier1, it indicates that the location to place the file that satisfies the placement condition is limited to Tier1 (the second storage tier) or any lower storage tier.

Next, the content of the object attribute table 1164 will be explained with reference to FIG. 15 to FIG. 17. The object(s) is a concept including files and pages as described earlier. The object attribute table 1164 stores necessary information to decide in which storage tier each object should be stored. Specifically speaking, the object attribute table 1164 stores integrated attribute information about pages and files necessary for the tier control, using common entries.

The object attribute table 1164 is created by the integrated tier control module 1153 based on the file and the page attribute information obtained from the file-based tier control module 1155 and the page-based tier control module 1157. The file and page attribute information can be obtained by placing the object attribute table 1164 in a shared memory between the integrated tier control module 1153 and the file-based tier control module 1155 or the page-based tier control module 1157 and performing exclusive control and shared access between the modules. If an update flag is provided and set on, information about an object(s) regarding which, for example, an update has been performed since the last time the integrated tier control module 1153 referred to the relevant object(s) may be sent from the file-based tier control module 1155 or the page-based tier control module 1157 to the integrated tier control module 1153.

The content of an attribute table 120 about objects (pages) belonging to the root storage tier in the pool 21 will be explained with reference to FIG. 15. If an arbitrary page in the virtual volume 26 is accessed from the host 14, the page-based tier control module 1157 allocates a page in the root storage tier, which is not allocated to any of the sub-storage tiers, to the relevant page in the virtual volume 26 as described earlier. The page-based tier control module 1157 refers to the migration policy and executes the page-based tier control in the same manner as the file-based tier control module 1155.

Like the file attribute table 1162, the page attribute table 1163 includes attribute information about each page such as the data change date and time, the last access date and time, and the access frequency and may also include migration policies. The information stored in the page attribute table 1163 is provided from the page-based tier control module 1157 to the integrated tier control module 1153, and the table 120 indicating the attributes of objects included in the root storage tier as shown in FIG. 15 is created based on the above information.

As shown in FIG. 15, the table 120 indicating the attributes of objects included in the root storage tier includes, for example, an object ID column 121, a size column 122, a tier limitation column 123, a priority column 124, a present tier column 125, a next tier column 126, and an update column 127.

The object ID column 121 stores the number for identifying the relevant object (page) in the root storage tier. The page identification number corresponds to the object identification number on one-to-one basis. The size column 122 stores the data size of the relevant object. If the object is a page, the data size has a fixed length; and, therefore, the same value (for example, 1 MB) is stored in the size column 122 for all the objects.

The tier limitation column 123 stores a limitation condition for a storage tier in which the relevant object is to be placed. If the tier limitation column 123 stores the number for identifying a storage tier, it means that the target object should be placed in a storage tier that satisfies the condition in the tier limitation column 123; and such a condition should be prioritized over the condition stored in the priority column 124. For example, if the location to place the relevant page is limited by the placement condition for the page, which is included in the migration policy, that location is stored in the tier limitation column 123.

The priority column 124 stores information indicating the priority according to which the relevant object is placed in a high storage tier from among a plurality of storage tiers. The object placement priority is decided based on the page attribute information in accordance with rules specified by policies designated by programs or the user. For example, if a value of the object is decided according to the access frequency, a value proportional to the access frequency value of the page is stored in the priority column 124. Furthermore, if a value of the object is decided according to the last access date and time, a value of the object of the highest priority, which is an object whose last access date and time is the latest, is stored in the priority column 124. As a result, the object that was accessed recently is recognized as a significant object. Moreover, a value to be stored in the priority column 124 may be decided by using a plurality of attribute values included in the page attribute table 1163, weighting each of the attribute values, and combining them.

The present tier column 125 stores information indicating a storage tier where each object (page) is placed at present. The next tier column 126 stores information indicating a storage tier where the object (page) is to be relocated. The storage tier where the object is to be relocated is decided by the integrated tier control module 1153. The page-based tier control module 1157 recognizes an object to be migrated and a new location to store the object based on the information stored in the next tier column 126.

The update column 127 stores information indicating whether the information stored in the attribute table 120 has been updated or not. For example, if any entry constituting the attribute table 120 has been updated, a character string x is stored in the update column 127. If the information stored in the table 120 is provided from the page-based tier control module 1157 to the integrated tier control module 1153, the information stored in the update column 127 becomes a flag indicating that the attribute value has been updated by the page-based tier control module 1157.

If the information stored in the table 120 is provided from the integrated tier control module 1153 to the page-based tier control module 1157, the information stored in the update column 127 becomes a flag indicating that the attribute value has been updated by the integrated tier control module 1153. The page-based tier control module 1157 and the integrated tier control module 1153 can narrow down the objects to refer to by referring to the flag stored in the update column 127, thereby reducing processing time for tier control.

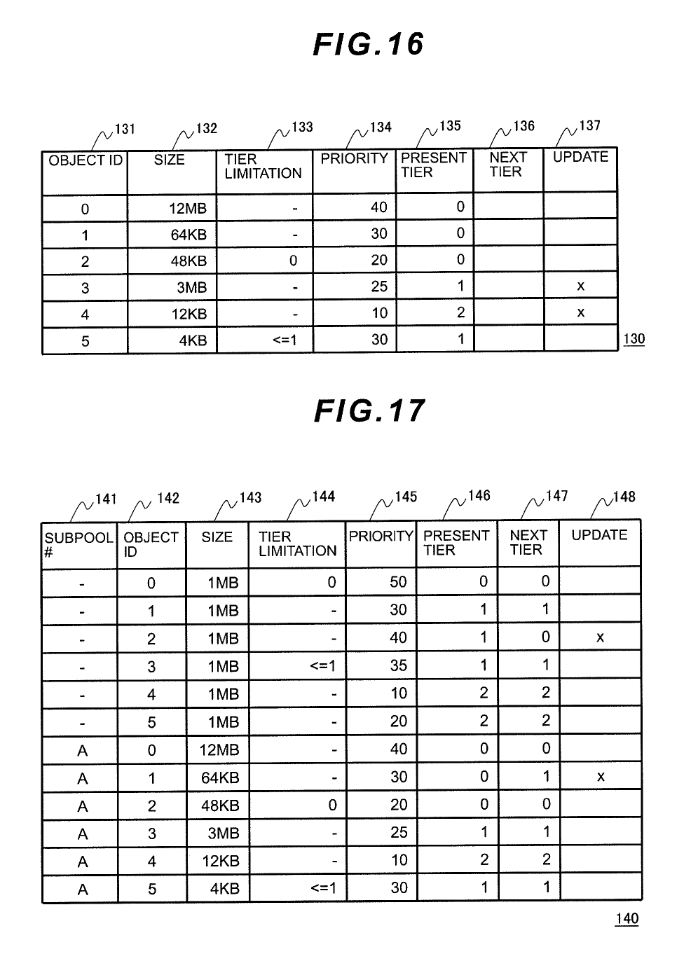

Next, the content of an attribute table 130 about objects (files) belonging to the subpool A in the pool 21, which is included in the object attribute table 1164, will be explained with reference to FIG. 16. The content of the attribute table about objects belonging to the subpool A as an example of the subpool will be explained with reference to FIG. 16; however, attribute tables for other subpools, similar to the attribute table 130, are also stored in the configuration information 1159.

Since the configuration of the attribute table 130 is almost the same as that of the above-described attribute table 120, the difference between the attribute table 130 and the attribute table 120 will be explained. An object ID column 131 stores the number for identifying the relevant object (file) in the subpool A. The file identification number corresponds to the object identification number on a one-to-one basis. A size column 132 stores the data size of the relevant object (file). If the object is a file, the file size has a variable length; and, therefore, different values are stored in the size column 122 for each object.

Information indicating the priority to place the object in the high storage tier from among a plurality of storage tiers is stored as a value stored in a priority column 134 like the priority column 124 in the attribute table 120, and the priority is decided based on the file attribute information. If the object is a file, the data size is different for each file; and therefore, the significance of the object may be decided using the number of accesses per unit size. The number of accesses per unit size is calculated by, for example, dividing the access frequency by the data size of the object.

Next, the content of a table 140 that integrates the attributes of objects in the entire pool included in the object attribute table 1164 will be explained with reference to FIG. 17. The table 140 can be said to be a table that integrates the attributes of pages belonging to virtual volumes and files belonging to subpools. As shown in FIG. 17, a subpool number column 141 is added to the table 140 as compared to the table 120 or the table 130. If the object is a page, it does not belong to any subpool; and therefore, no value is stored in the subpool number column 141. If the object is a file, the name of a subpool to which each file belongs is stored in the subpool number column 141.

If the object is a page, each page is identified only by the value stored in an object ID 142. If the object is a file, each file is identified uniquely by the values stored in the subpool number column 141 and the object ID 142. Since other items are the same as those in the table 120 or the table 140, a detailed description thereof has been omitted.

The integrated tier control module 1153 decides the optimum storage tier to place each object based on the attribute information about all the objects and stores it in a next tier column 146 in the table 140. If a value different from a value in a present tier column 145 is stored in the next tier column 146, the value x indicating a data update is stored in an update column 147. Then, the integrated tier control module 1153 copies the values, which are obtained by integrating the attributes of objects in the entire pool and stored in the table 140, to the table 120 indicating the attributes of pages and the table 130 indicating the attributes of files, respectively. Subsequently, the table 120 and the table 130, whose data is updated by the integrated tier control module 1153, are supplied to the page-based tier control module 1157 and the file-based tier control module 1155, respectively. Processing executed by the integrated tier control module 1153 for deciding the optimum storage tier to place each object will be explained later in detail.

### (1-4) Details of Actions of Storage Apparatus

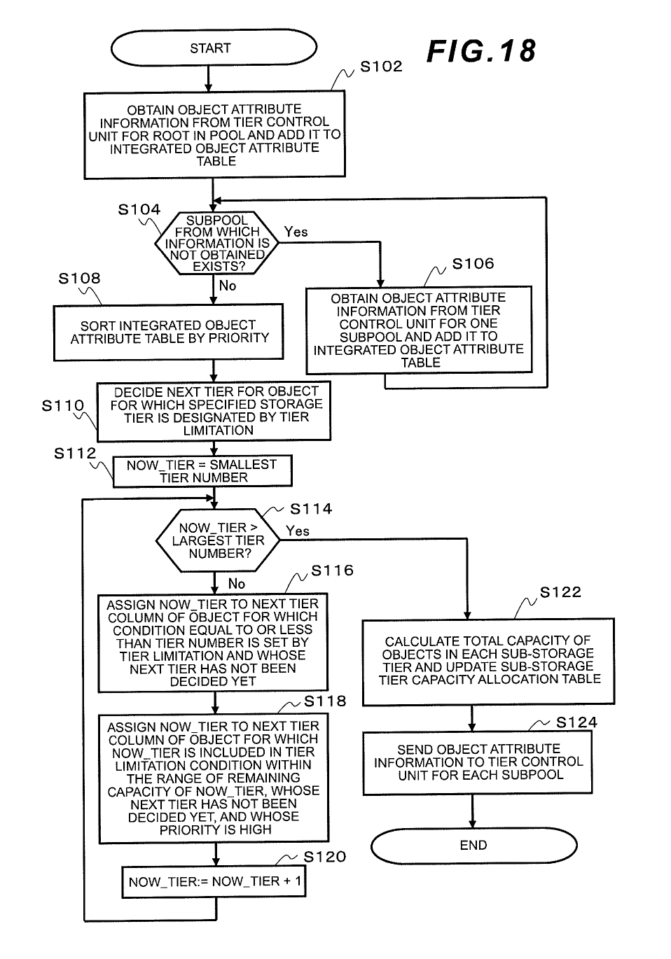

Next, the details of actions of the storage apparatus 11 will be explained with reference to FIG. 18 to FIG. 22. Firstly, processing executed by the integrated tier control module 1153 for deciding an optimum storage tier to place each object based on the above-described object attribute table 1164 will be explained with reference to FIG. 18. As shown in FIG. 18, the integrated tier control module 1153 firstly obtains the object (page) attribute information from the page-based tier control module 1157, which controls objects (pages) belonging to the root storage tier in the pool, and adds it to the object attribute table 140 in which the page attribute information and the file attribute information are integrated (S102).

The integrated tier control module 1153 then judges whether or not there is any object (file) attribute information which has not been obtained and belongs to a subpool (S104). If it is determined in step S104 that there is the attribute information about a subpool which has not been obtained, the integrated tier control module 1153 obtains the object (file) attribute information about one subpool from the subpool tier control module (the file-based tier control module 1155) and adds it to the integrated object attribute table 140 (S106). The integrated tier control module 1153 repeats step S104 and step S106, obtains the object attribute information about all the subpools, and adds it to the integrated object attribute table 140.

If it is determined in step S104 that the attribute information about all the subpools has been obtained, the integrated tier control module 1153 sorts the object attribute information stored in the integrated object attribute table 140 by the values stored in the priority column 145 (S108).

Subsequently, the integrated tier control module 1153 refers to the tier limitation column 144 in the integrated object attribute table 140; and if a single storage tier to place the relevant object is designated, the integrated tier control module 1153 decides the designated storage tier to be the next tier (S110). In step S110, the integrated tier control module 1153 stores the number of the designated storage tier in the next tier column 146.

Next, the integrated tier control module 1153 sets the smallest storage tier number as an initial value for a loop counter Now_Tier (S112). Since the tier number of the first storage tier is set to 0 (Tier0), the tier number of the second storage tier is set to 1 (Tier1), and the tier number of the third storage tier is set to 2 (Tier2) in this embodiment, the integrated tier control module 1153 sets the smallest storage tier number 0.

Then, the integrated tier control module 1153 judges whether the value set to the loop counter Now_Tier is the largest storage tier number (the storage tier number=2 in this embodiment) or not (S114). If it is determined in step S114 that the loop counter Now_Tier is not the largest storage tier number, the integrated tier control module 1153 executes processing in step S116. On the other hand, if it is determined that the loop counter Now_Tier is the largest storage tier number, the integrated tier control module 1153 executes processing in step S122.

In step S116, the integrated tier control module 1153 stores the Now_Tier value in the next tier column 146 for an object for which the condition of the tier limitation column 143 in the integrated object attribute table 140 is equal to or less than the Now_Tier value set to the loop counter, and whose next tier has not been decided yet (S116).

Subsequently, the integrated tier control module 1153 stores the Now_Tier value in the next tier column 146 in descending order of values stored in the priority column 144 within the range of the remaining capacity of the storage tier corresponding to the value set to the Now_Tier (S118). If the Now_Tier value does not satisfy the condition stored in the tier limitation column 143 in step S118, the integrated tier control module 1153 does not store the Now_Tier value in the next tier column 146.

If the first host 14 or the second host 15 makes new write access to the highest storage tier, a certain capacity to store a new object may be secured in the root storage tier or the sub-storage tier. In this case, when allocating a page(s) in step S118, the number of pages obtained by subtracting the number of pages to store the new object from the number of pages stored in the number-of-available-pages column 92 in the sub-storage tier capacity allocation table 53 may be set as the capacity capable of allocating pages. Also, with regard to storage tiers other than the highest storage tier, the number of pages obtained by subtracting a specified number of pages from the number of available pages may be set as the capacity capable of allocating pages in order to be prepared for a case where unused blocks are distributed to a plurality of allocated pages and a larger number of pages than the total capacity of files are thereby used, or for a case where the file size increases as data is added to the existing file(s).

After the processing in step S118, the integrated tier control module 1153 sets a value obtained by adding 1 to the loop counter Now_Tier to Now_Tier (S120). The integrated tier control module 1153 then repeats the processing in step S114 to step S120; and if it is determined that the loop counter Now_Tier is the largest value of the storage tier number, that is, if it is determined that allocation of pages to all the storage tiers has been completed, the integrated tier control module 1153 executes processing in step S122.

In step S122, the integrated tier control module 1153 updates the number-of available-pages column 92 in the sub-storage tier capacity allocation table 53 based on the result of allocation of the objects to the storage tier (S122). Specifically speaking, the integrated tier control module 1153 tallies the object size for each storage tier number stored in the next tier column 146 in the integrated object attribute table 140. Furthermore, if the subpool number column 141 stores the subpool number, the object size is tallied for each storage tier in the subpool, that is, for each sub-storage tier. The integrated tier control module 1153 converts the object size tallied for each sub-storage tier to the number of pages and stores it in the number-of-pages-in-use column 93.

With regard to the root storage tier and the highest sub-storage tier, the integrated tier control module 1153 stores the number of pages obtained by adding the number of pages for storing a new object, which was secured in step S118 (for example, 3000 pages), to the number of pages in use, in the number-of-available-pages column 92. Also, with regard to the sub-storage tiers other than the highest sub-storage tier, the integrated tier control module 1153 may store the number of pages obtained by adding a certain number of pages (for example, 1000 pages) to the number of pages in use, in the number-of-available-pages column 92. If empty pages are insufficient in each storage tier and it is impossible to secure the number of pages equal to or more than the above-described number of pages in use, the user may be warned via the management terminal 16. The warned user executes operation such as addition of storage media. Furthermore, the capacity which has not been allocated to either the root storage tier or the sub-storage tiers may be added to the number of pages in the number-of available-pages column 92 for the root storage tier.

Then, the integrated tier control module 1153 provides the object attribute information, for which each module takes charge in the tier control, from among the attribute information stored in the integrated object attribute table 140, to the page-based tier control module 1157 and each subpool tier control module (the file-based tier control module 1155) (S124). In step S124, the integrated tier control module 1153 copies the values stored in the integrated object attribute table 140 to the respective items for the relevant object in the table 120 indicating the page attributes and the table 130 indicating the file attributes.

The integrated tier control module 1153 may execute the above-described processing for deciding the placement of objects to storage tiers at regular time intervals or after the elapse of a certain period of time since the last relocation. Alternatively, the above-described object placement processing may be executed according to input by the user via the management terminal 16.

With respect to an object whose value stored in the present tier column in the attribute table 120 or the attribute table 130 does not corresponds with the value stored in the next tier column, the page-based tier control module 1157 and the file-based tier control module 1155, to which the object attribute information after the decision on the placement to the storage tier was provided from the integrated tier control module 1153, change the storage tier to store that object and executes migration between the storage tiers.

Since the page migration processing by the page-based tier control module 1157 just changes the location to store the relevant page, a detailed description thereof has been omitted. On the other hand, the file migration processing by the file-based tier control module 1155 judges whether or not an empty page is generated by migrating files of different sizes; and then notifies the page-based tier control module 1157 of the judgment result.

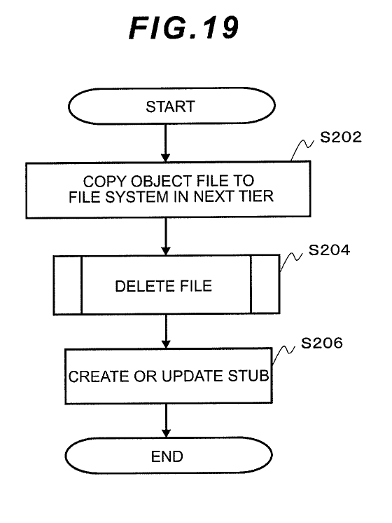

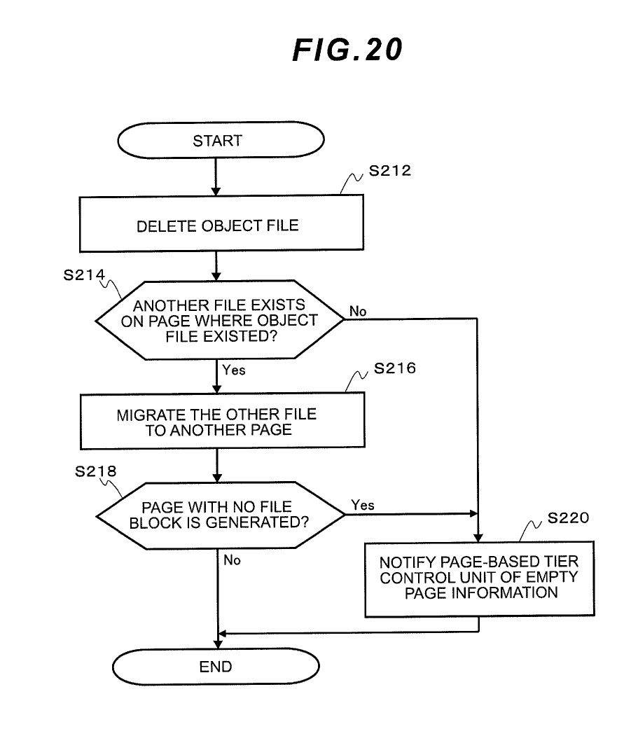

The file migration processing by the file-based tier control module 1155 will be explained with reference to FIG. 19 and FIG. 20. As shown in FIG. 19, the file-based tier control module 1155 firstly copies an object file to the storage tier stored in the next tier column 136 with respect to the object file whose value stored in the present tier column 135 in the attribute table 130 does not correspond with the value stored in the next tier column 136 (S202).

The file-based tier control module 1155 then deletes the object file which exists in the storage tier from which it was copied (S204). Deletion of the object file in step S204 will be explained later in detail. Finally, the file-based tier control module 1155 creates or updates a stub (S206). As mentioned earlier, the stub is a pointer indicating the position of actual data of the relevant file. Since a file system is configured in the highest sub-storage tier, if the file does not exist in the highest sub-storage tier, the stub associated with the file indicates a path name of the file and the position of actual data of the file. The actual data of the file is indicated with the name of the sub-storage tier and the path name in the sub-storage tier.

If the file which is a migration object is to be migrated from the highest sub-storage tier to a lower sub-storage tier, the file-based tier control module 1155 creates a new stub corresponding to that file. If the file which is a migration object is to be migrated between the sub-storage tiers other than the highest sub-storage tier, the file-based tier control module 1155 changes the position of actual data of the file which is indicated by the stub. If the file which is a migration object is to be migrated from the sub-storage tier other than the highest sub-storage tier to the highest sub-storage tier, the file-based tier control module 1155 replaces the stub corresponding to the file with the actual data in step S202.

Next, the object file deletion processing in step S204 in FIG. 19 will be explained with reference to FIG. 20. As shown in FIG. 20, the file system module 1154 firstly updates the configuration of the file system and deletes the object file (S212). The file-based tier control module 1155 then judges whether or not blocks constituting another file exist in the page where the file which was the deleted object existed (S214). If it is determined in step S214 that blocks constituting another file exist in the page where the file which was the deleted object existed, the file-based tier control module 1155 attempts to migrate the blocks constituting another file existing in that page to unused blocks in another allocated page.

Subsequently, the file-based tier control module 1155 judges whether or not a page where blocks constituting a file do not exist is generated as a result of the block migration in step S216 (S218). If it is determined in step S218 that a page where blocks constituting a file do not exist is generated, the file-based tier control module 1155 notifies the page-based tier control module 1157 of empty page information (S220). The page-based tier control module 1157 which is notified of the empty page information in step S220 has that page make the transition to an unallocated state and adds the number of empty pages to the number-of-pages-in-use column 93 in the sub-storage tier capacity allocation table 53. As a result of this processing, pages which were once allocated to the sub-storage tiers and have become unused as a result of the file migration can be collected to the root storage tier.

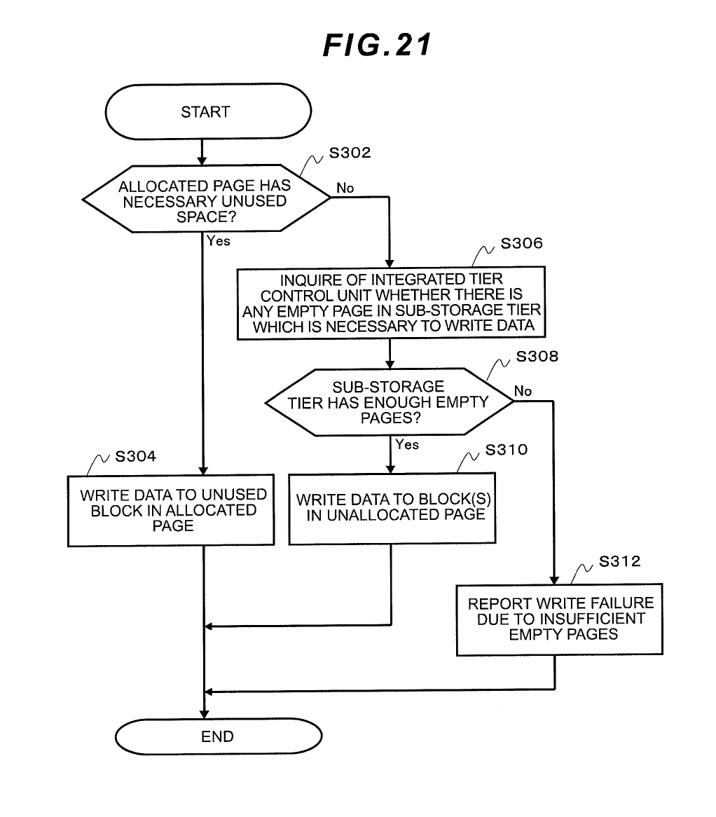

Next, the file write processing by the file system module 1154 will be explained with reference to FIG. 21. The following explanation will be given about write processing in a case where a new file is written or where a new block(s) is required when adding data to an existing file. As shown in FIG. 21, the file system module 1154 firstly judges whether or not a necessary unused capacity exists in an allocated page of the sub-storage tier where the file system to which the file is to be written exists (S302).

If it is determined in step S302 that the necessary unused capacity exists in the allocated page of the sub-storage tier, the file system module 1154 executes the processing for writing the file to the unused blocks in the allocated page (S304). If it is determined in step S302 that the necessary unused capacity does not exists in the allocated page, the file system module 1154 inquires of the integrated tier control module 1153 whether or not a necessary number of empty pages exists in the sub-storage tier where the file system to which the file is to be written (S306). The integrated tier control module 1153 refers to the number of available pages in the sub-storage tier capacity allocation table 53 shown in FIG. 12; checks if the necessary number of empty pages exists in the relevant sub-storage tier; and then notifies the file system module 1154 of the check result.

After receiving the notice from the integrated tier control module 1153, the file system module 1154 judges whether or not the sub-storage tier has sufficient empty pages (S308). If it is determined in step S308 that the sub-storage tier has sufficient empty pages, the file system module 1154 executes the processing for writing the file to a block(s) in an unallocated page (S310). If it is determined in step S308 that the sub-storage tier does not have sufficient empty pages, the file system module 1154 notifies the first host 15, which initially called the file system module 1154, of the insufficiency of the unused capacity to write the file (S312).

In order to prevent a failure of the file write processing due to the insufficiency in the unused capacity in step S312, empty pages in the root storage tier or other sub-storage tiers belonging to the same tier as that of the sub-storage tier which is the write object may be allocated temporarily. Also, a failure of the file write processing occurs when the capacity of the allocated pool is not sufficient for the amount of data to be written and sufficient reserve pages cannot be secured. Therefore, a system for assisting an appropriate addition to the pool capacity is required by, for example, giving a warning if the amount of data to be written exceeds a specified threshold for the pool capacity.

In the above explanation, the file write processing is executed after checking in advance in step S306 if there are empty pages in the integrated tier control module 1153; however, the invention is not limited to this example. For example, the processing in step S306 may be omitted. Specifically speaking, if the back-end module 1158 receives a write command from the file system module 1154 and the empty pages are insufficient, the back-end module 1158 may notify the file system module 1154 of an error relating to the write command.

In the above explanation, the integrated tier control module 1153 associates an increase or decrease of the value in the number-of-available-pages column 92 for the sub-storage tier in the sub-storage tier capacity allocation table 53 in FIG. 12 with the total file capacity of each sub-storage tier when deciding the placement of objects to the storage tier. Specifically speaking, the integrated tier control module 1153 increases or decreases the number of pages stored in the number-of-available-pages column 92 according to the data capacity of objects placed in the sub-storage tier.

However, there is a possibility that the user may set the capacity allocation of the sub-storage tier without the automatic capacity allocation along with the tier control by the integrated tier control module 1153. For example, the number of pages to be stored in the number-of-available-pages column 92 in the sub-storage tier capacity allocation table 53 may be set by the user input via the management terminal 16. In this case, if the number of pages is added to the number-of-available-pages column 92, it is only necessary to increase the value of the number of pages according to the user input.

Furthermore, if the sub-storage tier is used as a block-based storage area or used from a file system which is not in cooperation with the storage control program 1151, a desired number of pages cannot be reduced unless the number of pages to be reduced is equal to or less than the number of pages obtained by subtracting the number of pages in use from the number of available pages. However, if the storage control program 1151 is in cooperation with the file system module 1154 as in this embodiment, the processing for reducing the number of pages may be executed successfully even if the number of pages to be reduced is not equal to or less than the number of pages obtained by subtracting the number of pages in use from the number of available pages.

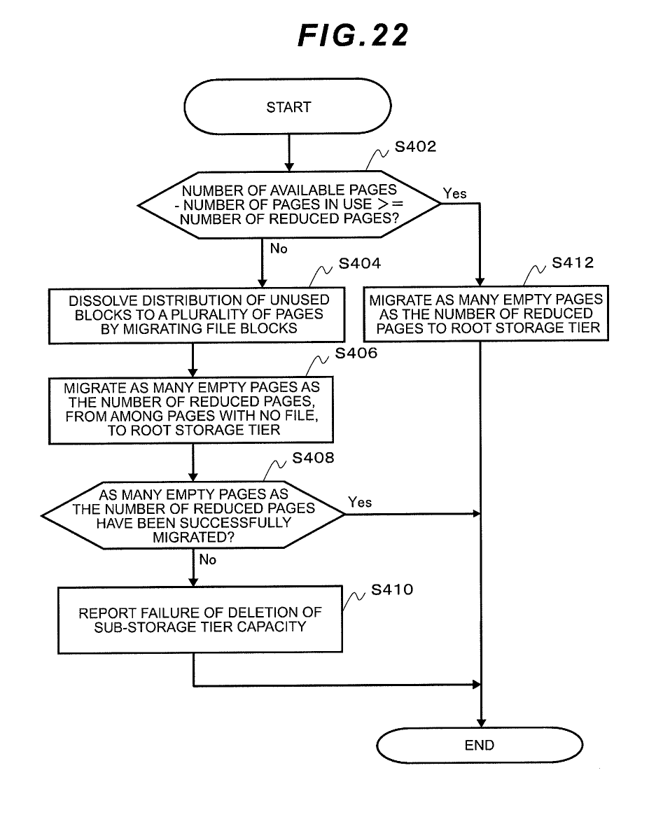

Next, processing for reducing a desired number of pages with respect to the number of available pages in a sub-storage tier where a file system exists will be explained with reference to FIG. 22. As shown in FIG. 22, the integrated tier control module 1153 firstly judges whether or not a value obtained by subtracting the number of pages in use from the number of available pages is equal to or more than the number of pages to be reduced, in response to input by the user via the management terminal 16 (S402). If it is found in step S402 that the value obtained by subtracting the number of pages in use from the number of available pages is equal to or more than the number of pages to be reduced, the integrated tier control module 1153 migrates as many empty pages in the sub-storage tier as the number of pages to be reduced to the root storage tier (S412).

If it is found in step S402 that the value obtained by subtracting the number of pages in use from the number of available pages is less than the number of pages to be reduced, the integrated tier control module 1153 notifies the file system module 1154 to that effect and dissolves distribution of unused blocks to a plurality of pages by migrating file blocks (S404). As many empty pages as the number of pages to be reduced, from among pages with no file, which are generated by the file block migration by the file system module 1154 in step S404, are migrated to the root storage tier (S406). In step S406, the integrated tier control module 1153 updates values in the available capacity column 91 and the number-of-available-pages column 92 for the root storage tier in the sub-storage tier capacity allocation table 53 to values corresponding to the number of reduced pages.

The integrated tier control module 1153 then judges whether or not the reduced pages as designated by the user have been successfully migrated by means of the empty page migration processing in step S406 (S408). If it is determined in step S408 that as many empty pages as the number of pages to be reduced have been successfully migrated, the processing is terminated. On the other hand, if it is determined in step S408 that the migration of as many empty pages as the number of pages to be reduced has failed, the failure in reduction of the designated pages is reported to the management terminal 16 (S410).

### (1-5) Advantageous Effects of this Embodiment

According to the above-described embodiment, the storage apparatus 11 can allocate not only pages in a pool to virtual volumes, which are objects of the page-based tier control, but also a specific storage tier in the pool to a sub-storage tier which is an object of the file-based tier control. As a result, the file-based tier control module 1155 can place a file in an intended storage tier.

Also, the file-based tier control module 1155 and the page-based tier control module 1157 can share the storage pool by integrating logical volumes constituting pages to be allocated to virtual volumes and logical volumes constituting pages to be allocated to sub-storage tiers into one storage pool (pool). As a result, it is possible to execute highly efficient tier control by flexibly changing the capacity of areas to be used by the file-based tier control module 1155 according to the actual capacity of data.

Moreover, the integrated tier control module 1153 compares the significance of different types of objects, that is, pages accessed according to the block protocol and files accessed according to the file protocol, according to the common standard. As a result, it is possible to decide a storage tier to place each object based on the significance of all the objects stored in one storage pool.

Furthermore, according to this embodiment, files are migrated or blocks constituting files are relocated based on the placement to the storage tier as decided by the integrated tier control module 1153. If an empty page(s) is generated as a result of the file migration or relocation, it is possible to collect the empty page(s) by reducing the capacity allocated to the sub-storage tier.

### (2) Second Embodiment

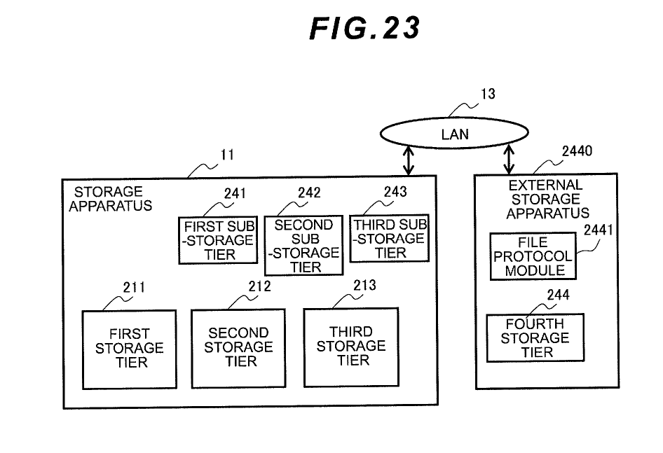

Next, a second embodiment of this invention will be explained with reference to FIG. 23. The difference between the first embodiment and the second embodiment is that an external storage apparatus 2440 exists in addition to the storage apparatus 11 and is connected to the storage apparatus 11 in the second embodiment. Particularly, the configuration different from the first embodiment will be explained below in detail. FIG. 23 is a conceptual diagram showing the configuration where the external storage apparatus 2440 is connected to the storage apparatus 11.

As shown in FIG. 23, the external storage apparatus 2440 is connected via the LAN 13 to the storage apparatus 11. When writing data to, or reading data from, a fourth storage tier 244 constituting the external storage apparatus 2440, the fourth storage tier 244 can be accessed only according to the file protocol processed by a file protocol module 2441. Also, the fourth storage tier 244 is constituted from storage media in a lower tier than the first storage tier to the third storage tier, and an example of such storage media can include tape storage media.

Accordingly, data stored in the fourth storage tier 244 becomes data of lower significance than data stored in the first storage tier to the third storage tier in the storage apparatus 11. In the first embodiment, the subpool 24 is constituted from the first sub-storage tier 241, the second sub-storage tier 242, and the third sub-storage tier 243. On the other hand, in this embodiment, the subpool 24 is constituted from four storage tiers by including the fourth storage tier added to the first sub-storage tier 241, the second sub-storage tier 242, and the third sub-storage tier 243.

The external storage apparatus 2440 does not have to be always active and may be made to be active only when a file is stored in the fourth storage tier. The external storage apparatus 2440 is accessed only according to the file protocol in this embodiment, but the invention is not limited to this example; and the external storage apparatus 2440 may be configured so that it is connected via a SAN to the storage apparatus 11 and accessed according to the block protocol.

Since the external storage apparatus 2440 can be accessed only according to the file protocol as described above, the fourth storage tier 244 stores files. The file-based tier control module 1155 places files to the optimum storage tier according to the significance of the files, using the first sub-storage tier, the second sub-storage tier, and the third storage tier included in the storage apparatus 11, and the fourth storage tier in the external storage apparatus 2440.

For example, processing for specifying a subpool which can be allocated to the fourth storage tier 244 is added to step S118 of the processing for deciding the optimum storage tier to place an object as shown in FIG. 18. As a result, it is possible to prevent a file which should be placed from the first storage tier to the third storage tier in the storage apparatus 11 from being placed in the fourth storage tier. Furthermore, regarding data to be stored in a subpool included in the fourth storage tier, data stored in other subpools may be placed in the fourth storage tier even if the significance of data stored in a subpool included in the fourth storage tier is higher than that of data stored in other subpools, only if the significance difference is within a certain range. Consequently, it is possible to avoid the capacity shortage in higher tiers than the third storage tier in the entire pool by executing migration to the fourth storage tier.

### (3) Third Embodiment

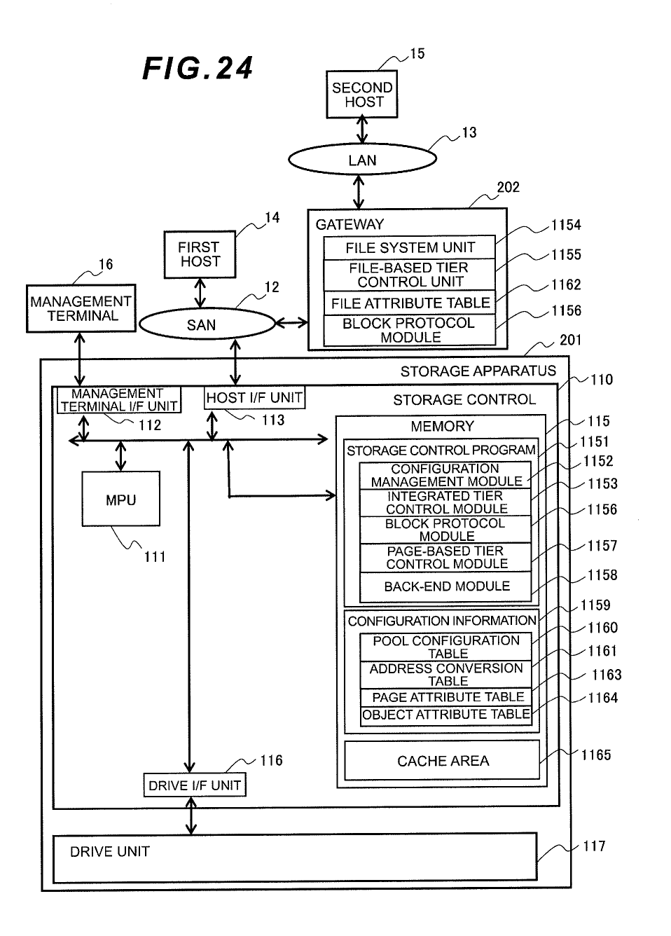

Next, the third embodiment of this invention will be explained with reference to FIG. 24. The difference between the first embodiment and the third embodiment is that the third embodiment has a function equivalent to that of the storage apparatus 11 according to the first embodiment by means of a gateway 202 connected to a storage apparatus 201 via a SAN 12.

As shown in FIG. 24, the storage apparatus 201 has, like the first embodiment, a function changing parameters such as the configuration of logical volumes in storage areas in response to a command sent from the management terminal 16 and is mainly constituted from, for example, a controller 110 and a drive unit 117. The storage apparatus 201 also has, besides the file-based tier control function, a page-based tier control function and an integrated tier control function. Since the page-based tier control function and the integrated tier control function of the storage apparatus 201 are the same functions as those in the first embodiment, a detailed description thereof has been omitted.

The block protocol module 1156 for the storage apparatus 201 executes a block access command sent from the first host 14 and the gateway 202. The gateway 202 receives a file access command sent from the first host 15, converts it into a block access command, and sends it to the storage apparatus 201. As shown in FIG. 24, the gateway 202 has, for example, the block protocol module 1156, a file system unit 1154, the file-based tier control module 1155, and the file attribute table 1162. The gateway 202 has a file system control function and a file-based tier control function. Since the file system control function and the file-based tier control function of the gateway 202 are the same as those in the first embodiment, a detailed description thereof has been omitted.

In this embodiment, the storage apparatus 201 and the gateway 202 are connected via the SAN 12 to perform communication according to the block protocol; however, the invention is not limited to this example. For example, the storage apparatus 201 and the gateway 202 may be connected via a LAN to perform communication according to the file protocol via the LAN. In this case, the storage apparatus 201 converts the file protocol into the block protocol.

Like the storage apparatus 11 in the first embodiment, the storage apparatus 201 has a plurality of subpools configured in one pool and a plurality of sub-storage tiers included in one subpool. One sub-storage tier in the subpool is provided as one logical volume to the gateway 202. Furthermore, data is written to, or read from, each sub-storage tier by means of the back-end module 1158 using a standard block access command.

The gateway 202 sends the file attribute table 1162 storing file attribute information to the storage apparatus 201. Then, the integrated tier control module 1153 for the storage apparatus 201 stores information of the file attribute table 1162, which has been sent from the gateway 202, in the object attribute table 1164. The integrated tier control module 1153 also stores information, which is stored in the page attribute table 1163, in the object attribute table 1164. As a result, the page attribute information and the file attribute information are integrated into the object attribute table 1164.

Like the first embodiment, the integrated tier control module 1153 decides a storage tier to place a page and a file by comprehensively judging, for example, the significance of the object regardless of the type of the object, whether a page or a file. As a result, even if the gateway 202 which is a device separate from the storage apparatus 201 has a function managing data accessed on a file basis from the first host 15, such as the file system module 1154 and the file-based tier control module 115, it is possible to decide a storage tier to place each object based on the significance of all the objects stored in one storage pool.

Furthermore, in this embodiment like the first embodiment, the file-based tier control module 1155 for the gateway 202 and the page-based tier control module 1157 for the storage apparatus 201 can share the storage pool. As a result, it is possible to execute highly efficient tier control by flexibly changing the capacity of an area used by the file-based tier control module 1155 according to the actual capacity of data.

### (4) Other Embodiments

Preferred embodiments of this invention have been described in detail with reference to the attached drawings. However, this invention is not limited only to these embodiments. It is apparent that a person with an ordinary skill in the art to which the invention pertains could easily think of various change examples or modification examples within the category of technical ideas described in the scope of claims. It is understood as a matter of course that such change examples or modification examples also belong to the technical scope of this invention.

For example, steps in the processing by, for example, the storage apparatus 11 as described in this specification do not necessarily have to be executed chronologically in the order described in the relevant flowchart. In other words, each step in the processing by the storage apparatus 11 may be executed in different processing or those steps may be executed in parallel.

Furthermore, it is possible to create a computer program for having the hardware such as the CPU, ROM, RAM, etc. contained in, for example, the storage apparatus 11 fulfill functions equivalent to those of each component of the storage apparatus 11 described earlier. It is also possible to provide a storage medium in which such a computer program is stored.

### INDUSTRIAL APPLICABILITY

The present invention can be applied to a computer system that uses storage media areas efficiently by flexibly changing the allocation of the capacity to storage media areas used by page-based tier control and storage media areas used by file-based tier control.

### REFERENCE SIGNS LIST

11, 201 Storage apparatuses
12 SAN
13 LAN
14 First host
15 Second host
16 Management terminal
110 Controller
111 MPU
112 Management terminal I/F unit
113 First host I/F unit
114 Second host I/F unit
115 Memory
116 Drive I/F unit
117 Drive unit
1151 Storage control program
1152 Configuration management module
1153 Integrated tier control module
1154 File system module
1155 File-based tier control module
1156 Block protocol module
1157 Page-based tier control module
1158 Back-end module
1159 Configuration information
1160 Pool configuration table
1161 Address conversion table
1162 File attribute table
1163 Page attribute table
1164 Object attribute table
1165 Cache area

1. A storage apparatus connected via a network to a host system issuing a data write request, the storage apparatus comprising:
a configuration management unit for managing a storage area as a pool; and
an allocation unit for allocating the storage area of the pool to a data storage area of a virtual volume for storing the data in response to the data write request from the host system;
wherein the configuration management unit manages a specified area of the pool as a plurality of subpools for storing file-based data; and
wherein the allocation unit increases or decreases an allocated capacity of the subpools according to the size of data for which file-based writing is requested by the host system; and if the allocation unit receives a request from the host system to write data on a specified-sized page basis, it allocates an area other than the subpools; and if the allocation unit receives a request from the host system to write data on a file basis, it allocates an area in the subpools.

2. The storage apparatus according to claim 1, wherein the configuration management unit manages storage areas respectively provided by a plurality of types of storage devices with different performance as different storage tiers and also manages a plurality of different types of storage tiers as the pool;
the allocation unit allocates a specified area in any of the storage tiers in the pool to the data storage area; and
the configuration management unit manages the specified area in the pool, which has the plurality of different types of storage tiers, as the plurality of subpools for storing file-based data.

3. The storage apparatus according to claim 1, further comprising a file management unit for managing data stored in the subpool on a file basis,
wherein if the data stored in the subpool is deleted in response to a request from the host system, the file management unit notifies the allocation unit of an area where the data does not exist; and
the allocation unit cancels allocation to the subpool with respect to the area where the data does not exist as notified by the file management unit.

4. The storage apparatus according to claim 2, wherein the configuration management unit decides the capacity of the pool area managed as the subpools for each storage tier.

5. The storage apparatus according to claim 2, wherein the subpool is constituted from a plurality of different types of storage tiers, and
the allocation unit allocates a specific storage tier area in the pool to a data storage area in the subpools for storing the data in response to a file-based data write request from the host system.

6. The storage apparatus according to claim 2, further comprising:
a page-based tier control unit for, if a page-based data write request is issued from the host system, deciding the storage tier to store the page in the pool according to attribute information about the page;
a file-based tier control unit for, if a file-based data write request is issued from the host system, deciding the storage tier to store the file in the subpool according to attribute information about the file; and
an integrated tier control unit for deciding the storage tier to store the page and the file based on the page attribute information and the file attribute information.

7. The storage apparatus according to claim 6, wherein the allocation unit decides a capacity to be allocated to the subpool in each storage tier in the pool based on the decision of the integrated tier control unit on the storage tier to store the file.

8. The storage apparatus according to claim 7, wherein the file management unit stores the file in the subpool to which the capacity is allocated by the allocation unit.

9. The storage apparatus according to claim 6, wherein the integrated tier control unit generates attribute information by integrating the page attribute information and the file attribute information, compares priorities included in the integrated attribute information, and decides storage tiers to place all the pages and files included in the pool.

10. The storage apparatus according to claim 9, wherein the priorities included in the integrated attribute information are calculated based on frequency of access by the host system to the page or the file.

11. The storage apparatus according to claim 10, wherein the frequency of access to the file is the number of accesses to the page or the file per unit time or unit size.

12. The storage apparatus according to claim 9, wherein the integrated attribute information includes limitation information about the storage tier to store the page or the file, and
the integrated tier control unit decides the storage tier commensurate with the limitation information about the storage tier to be the storage tier to place the page or the file.

13. The storage apparatus according to claim 6, wherein the storage apparatus is connected via a network to an external storage apparatus;
the integrated tier control unit manages a storage device belonging to the external storage apparatus as a subpool for storing the file; and
if the pool in the storage apparatus is deficient in a specified area of the storage tier to be allocated to the virtual volume, the file included in the subpool of the storage apparatus is placed to the subpool of the external storage apparatus.

14. The storage apparatus according to claim 3, wherein the file management unit is provided in a device that is connected via the network to the storage apparatus and is separate from the storage apparatus.

15. A storage management method using a storage apparatus connected via a network to a host system issuing a data write request,
wherein storage areas provided respectively by a plurality of types of storage devices with different performance are managed as different storage tiers, and a plurality of types of storage tiers are managed as a pool, and a specified area in the pool is managed as a plurality of subpools for storing file-based data; and
wherein the storage management method comprises the steps of:
increasing or decreasing an allocated capacity of the subpools according to the size of data for which file-based writing is requested by the host system;
allocating an area other than the subpools if the host system issues a request to write data on a specified-sized page basis; and
allocating an area in the subpools if the host system issues a request to write data on a file basis.
